(19) United States
(12) Patent Application Publication
(10) Pub. No.: US 2017/0344911 A1
(43) Pub. Date: Nov. 30, 2017

(54) INFORMATION PROCESSING SYSTEM

(71) Applicant: TOYOTA JIDOSHA KABUSHIKI KAISHA, Toyota-shi (JP)

(72) Inventor: Kazuhiro SHIMURA, Tokyo (JP)

(73) Assignee: TOYOTA JIDOSHA KABUSHIKI KAISHA, Toyota-shi (JP)

(21) Appl. No.: 15/595,082

(22) Filed: May 15, 2017

(30) Foreign Application Priority Data
May 31, 2016 (JP) 2016-109085

(51) Int. Cl. G06Q 10/02; G06F 17/30; G06Q 10/08; H04W 88/02; G06Q 50/30

(52) U.S. Cl. CPC G06Q 10/02; H04W 88/02; G06Q 50/30; G06Q 10/08; G06F 17/3056; G06F 17/30386

(57) ABSTRACT

A position measurer measures the current position of a user terminal, and a time deriver derives an arrival time required before a vehicle arrives at the user's position, based on the current position of the user terminal and position information of the vehicle transmitted from a management server. A screen generating unit displays, as a list, information regarding the type of an available vehicle, and an arrival time required before the vehicle arrives at the user's position, on a display of an output device. The screen generating unit displays information regarding the type of each vehicle of which the arrival time is a given period of time or less.

The disclosure of Japanese Patent Application No. 2016-109085 filed on May 31, 2016 including the specification, drawings and abstract is incorporated herein by reference in its entirety.

### BACKGROUND

### 1. Technical Field

The present disclosure relates to an information processing system configured to display, on a user terminal, information regarding available vehicles.

### 2. Description of Related Art

JP-A-2002-367086 discloses a taxi arrangement system comprising a portable terminal that transmits, to a host computer, the name of the user, the number of passengers, conditions including the type (small size/large size), vehicle type, color, and company of the desired taxi, and the current position measured by a global positioning system (GPS), and also comprising the host computer that transmits, to the portable terminal, the scheduled arrival time of the taxi to be delivered to the user, and the characteristics, including the vehicle color, of the taxi selected according to the conditions specified by the user.

According to the technique disclosed in JP-A-2002-367086, the user can specify the conditions including the desired vehicle type, but there is a problem of late arrival time of the vehicle, at which the vehicle is delivered to the user, when a distant vehicle is selected according to the specified conditions.

Accordingly, construction of a scheme in which a user can select a vehicle in consideration of the arrival time is desired.

### SUMMARY

The disclosure has been made in view of such a situation, and a purpose thereof is to provide a technique by which a user can efficiently select an available vehicle.

To solve the problem above, an information processing system of an embodiment of the disclosure includes: a user terminal possessed by a user; a vehicle terminal mounted on a vehicle; and a management server capable of communicating with the user terminal and the vehicle terminal. The management server includes: a management unit configured to manage status information, which includes availability information indicating whether or not a vehicle is available and position information of a vehicle, and information regarding the type of a vehicle; an information extractor configured to extract, from the management unit, status information of a vehicle and information regarding the type of a vehicle; and a providing unit configured to provide information extracted by the information extractor to the user terminal.

The user terminal includes: an information acquirer configured to acquire provided information; a position measurer configured to measure the current position of the user terminal; and a screen generating unit configured to display, as a list on a display, information regarding the type of an available vehicle, and an arrival time required before the vehicle arrives at the user's position.

According to the embodiment, since a list of information regarding the types of vehicles and the arrival times of the vehicles is displayed on the display of the user terminal, the user can select a desired type of vehicle in consideration of the arrival time.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of a car sharing system according to an embodiment;

FIG. 2 is a diagram used to describe examples of use modes of a car sharing service;

FIG. 3 is a functional block diagram of a management server;

FIG. 4 shows a vehicle status table managed by a vehicle management unit;

FIG. 5 shows a staff status table managed by a staff management unit;

FIG. 6 shows a station status table managed by a station management unit;

FIG. 7 shows a user status table managed by a user management unit;

FIG. 8 shows an example of a map screen to be displayed;

FIG. 9 is a functional block diagram of a staff terminal;

FIG. 10 is a functional block diagram of a vehicle terminal;

FIG. 11 is a functional block diagram of a user terminal;

FIG. 12 shows an example of an initial screen to be displayed;

FIG. 13 shows an example of a vehicle check screen to be displayed;

FIG. 14 shows an example of a vehicle list screen to be displayed; and

FIG. 15 shows an example of a staff list screen to be displayed.

### DETAILED DESCRIPTION

Various embodiments will now be described by reference to the drawings. The embodiments are illustrative and are not intended to be limiting.

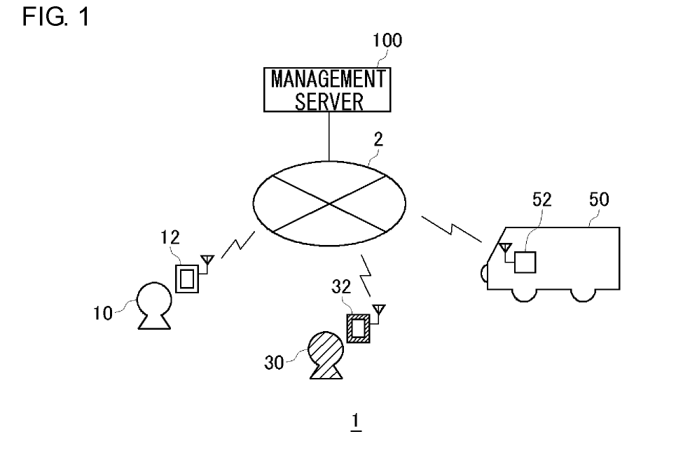

FIG. 1 shows a configuration of a car sharing system 1 according to an embodiment. The car sharing system 1 is an information processing system comprising a user terminal 12 possessed by a user 10, a staff terminal 32 possessed by a staff member 30, a vehicle terminal 52 mounted on a vehicle 50, and a management server 100 used to manage the car sharing service.

Each of the user terminal 12, staff terminal 32, and vehicle terminal 52 has a wireless communication function and connects to a network 2 via a wireless base station or a wireless access point. The management server 100 is also connected to the network 2 and can communicate with the user terminal 12, staff terminal 32, and vehicle terminal 52 via the network 2.

Although only a single user 10, a single staff member 30, and a single vehicle 50 are illustrated in FIG. 1, the car sharing service according to the embodiment is operated by multiple users 10, multiple staff members 30, and multiple vehicles 50. Accordingly, the management server 100 is connected to multiple user terminals 12, multiple staff terminals 32, and multiple vehicle terminals 52 so as to communicate therewith.

A user 10 is a member of the car sharing service who has signed up to use a vehicle. Time of vehicle usage of the user 10 is managed by the management server 100, and the user 10 pays a fee according to the time each month, for example. The user terminal 12 is a mobile terminal, such as a smartphone and a tablet terminal, on which an application for users (hereinafter, referred to as a “user application”) of the service has been installed.

In the car sharing system 1, a staff member 30 gets into a vehicle 50 and waits for a dispatch request from the management server 100. The user terminal 12 displays information regarding the types of vehicles available for the user 10 on the display, and, when the user 10 selects a desired vehicle 50, the user terminal 12 transmits a selection request to the management server 100. Upon reception of the selection request, the management server 100 allocates the selected vehicle 50 to the user 10 and transmits a dispatch request to the vehicle terminal 52 of the vehicle 50. When the staff member 30 in the vehicle 50 views the dispatch request, the staff member 30 drives the vehicle 50 to the place where the user 10 is and rents out the vehicle 50 to the user 10, who will then drive the vehicle 50 to a destination. The car sharing service differs from a taxi service in that users 10 themselves drive.

The user 10 may also select a vehicle 50 parked in a parking area (hereinafter, referred to as a “station”). The user terminal 12 displays, on the display, a list in which vehicles that can be delivered by staff members 30 and vehicles that, can be driven from stations are separated. When the user 10 selects a vehicle 50 that can be driven from a station, the user 10 visits the station to drive the vehicle 50 therefrom.

A staff member 30 is a person in charge of the service and belongs to the operating entity of the car sharing service. The staff member 30 has the roles of delivering a vehicle 50 to a user 10 and receiving a vehicle 50 returned by a user 10. The staff terminal 32 is a mobile terminal, such as a smartphone and a tablet terminal, on which an application for staff (hereinafter, referred to as a “staff application”) of the service has been installed.

A vehicle 50 is a vehicle used for car sharing. In the car sharing system 1, various types of vehicles may be suitably prepared so that a user 10 can freely select a desired type of vehicle. The types of vehicles generally mean those classified by use, make, or model year, but, in the embodiment, those classified by other standards may be further included. For example, vehicles may be distinguished by vehicle name or by vehicle body color, seating capacity, or vehicle body size. Since the information regarding the types of vehicles is displayed on the display of the user terminal 12, a user 10 can select a vehicle 50 to use based on the types of the vehicles. Accordingly, the types of vehicles for distinguishing the vehicles may be suitably set according to users' needs so that a user can easily select a desired vehicle.

In a conventional car sharing service, a user needs to visit a station in which vehicles are parked arid to return a vehicle to the same station after usage. The car sharing service according to the embodiment can provide users 10 with various use modes with improved convenience, besides the conventional use modes.

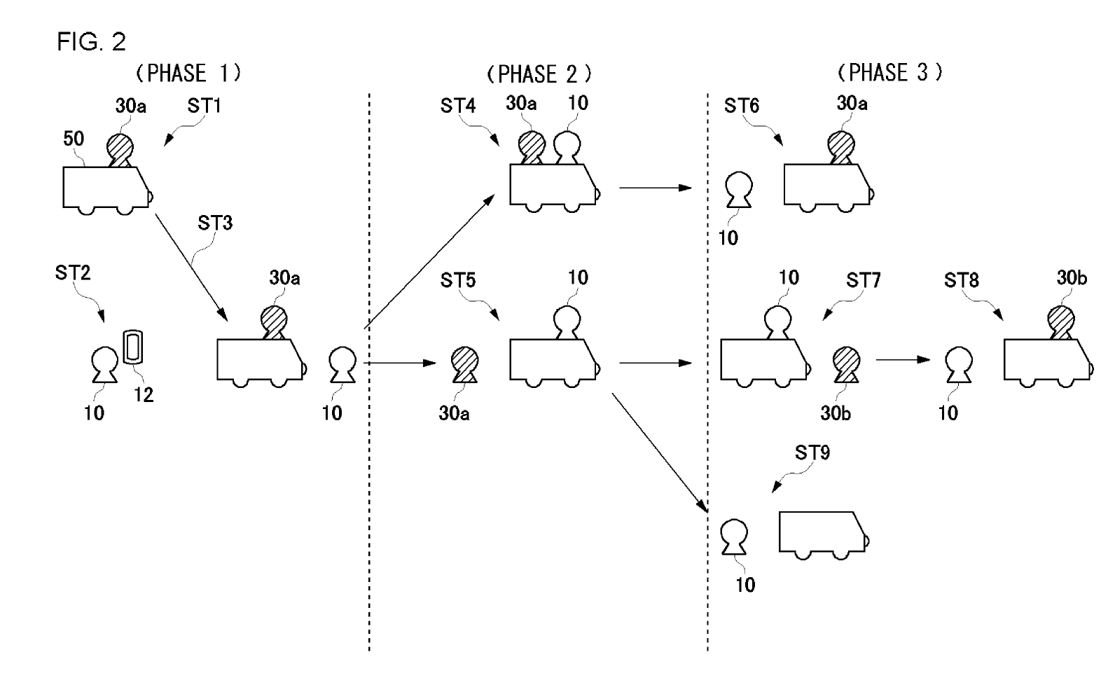

FIG. 2 is a diagram used to describe examples of use modes of the car sharing service. In the following, use modes of the service will be described in three phases.

(Phase 1: Stage Before the User's Driving)

A staff member 30a gets into a vehicle 50 and waits for a dispatch request (ST1). The area of which the staff member 30a is in charge is specified by the management server 100, and the staff member 30a waits for a dispatch request while driving the vehicle 50 within the area. The staff member 30a may drive the vehicle 50 according to a specified round route. Also, if there is a place where a vehicle can be stopped, within the area, the staff member 30a may stop the vehicle 50 in the place and wait for a dispatch request.

The user 10 operates the user terminal 12 to display information regarding the types of available vehicles on the display and selects a desired vehicle 50 (ST2). The user terminal 12 then transmits to the management server 100 a vehicle selection request that includes information for identifying the selected vehicle (vehicle ID), information for identifying the user 10 (user ID), and position information of the user terminal 12. Upon acquisition of the vehicle selection request, the management server 100 allocates the selected vehicle 50 to the user 10 and transmits a dispatch request to the vehicle terminal 52 of the vehicle 50. The dispatch request is configured to include at least a user name and user position information. Upon reception of the dispatch request, the vehicle terminal 52 displays, on the display, a message indicating that there is a dispatch request. The vehicle terminal 52 may automatically set the user position information as the destination of the navigation system to perform route guidance for the staff member 30a.

After the vehicle terminal 52 receives the dispatch request, the staff member 30a drives the vehicle 50 to the position where the user 10 is waiting (ST3). Since the staff member 30a delivers the vehicle 50 to the user 10, the user 10 has only to wait for the arrival of the vehicle 50 in the place where the user 10 has transmitted the vehicle selection request, without bothering to visit a station to pick the vehicle 50 up.

The car sharing system 1 also provides users with the conventional use mode of visiting a station to pick a vehicle 50 up, so that a user can use a vehicle parked in a station if the user so desires. In the car sharing service according to the embodiment, since a user can select a vehicle based on the type of the vehicle, if a desired type of vehicle is parked in a station, the user may select the parked vehicle.

(Phase 2: Stage of the User's Driving)

After the staff member 30a delivers the vehicle 50 to the user 10, the staff member 30a gets out of the driver's side, and the user 10 gets in the driver's side instead. If the user 10 wishes the staff member 30a to ride together, the staff member 30a will sit in the backseat or the passenger seat of the vehicle 50, and the user 10 will drive the vehicle 50 to the destination (ST4). On the other hand, if the user 10 does not wish the staff member 30a to ride together, the staff member 30a will not get into the vehicle 50 and the user 10 will drive the vehicle 50 to the destination (ST5). After getting out of the vehicle 50, the staff member 30a may walk to a near station and get into a parked vehicle there to wait for a dispatch request, or may receive a vehicle returned by another user, for example.

(Phase 3: Stage After the User's Driving)

If the staff member 30a rides with the user 10 (ST4), when the user 10 gets out of the driver's side after driving to the destination, the staff member 30a gets in the driver's side instead and moves the vehicle 50 (ST6). The vehicle 50 driven by the staff member 30a will be a standby vehicle that waits for a dispatch request. In this way, if the staff member 30a rides with the user 10, the staff member 30a can change the driving right after the user 10 drives to the destination, so that the user 10 does not need to park the vehicle 50 in a station. Thus, the embodiment provides a highly convenient service such that the user 10 can drive to a desired place.

If the staff member 30a does not ride with the user 10 (ST5), the user 10 returns, after driving to the destination, the vehicle 50 to another staff member 30b there (ST7), and the staff member 30b moves the vehicle 50 (ST8). The vehicle 50 driven by the staff member 30b will be at standby vehicle that waits for a dispatch request. For example, the user 10 may find out the staff member 30b on standby on a map screen displayed on the display of the vehicle terminal 52 and notify the staff member 30b of the destination so as to have the staff member 30b come to the destination. Alternatively, the user 10 may drive the vehicle 50 to the place where the staff member 30 is.

Also, if the staff member 30a does not ride with the user 10 (ST5), the user 10 may drive to a station near the destination and park the vehicle 50 there (ST9). In this case, a map screen indicating positions of available stations is displayed on the display of the vehicle terminal 52, so that the user 10 can check the places of the available stations on the map screen. In this use mode, although the user 10 needs to drive to a station, the user 10 can freely select an available station and can return the vehicle 50 to a station near the destination.

Although not shown in FIG. 2, in Phase 1, the user 10 may walk to a station to use a vehicle 50 parked there. In this case, a staff member 30 will not ride together in the vehicle 50, but the user 10 can return the vehicle 50 to a station near the destination (ST9) or can return the vehicle 50 to the staff member 30b at the destination (ST7).

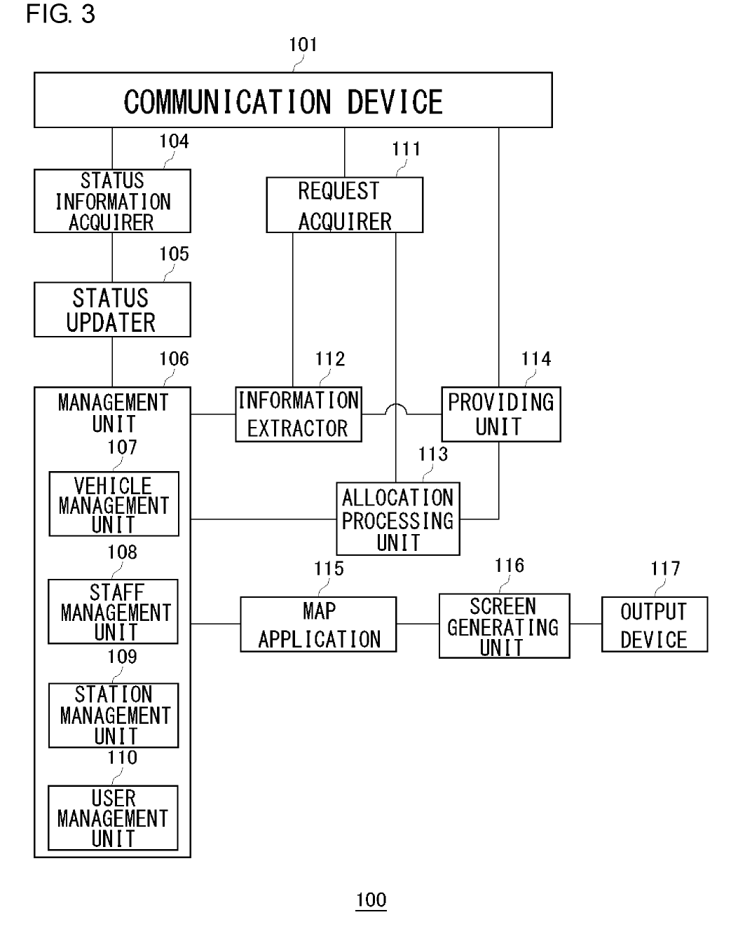

FIG. 3 is a functional block diagram of the management server 100. The management server 100 manages status information of users 10, staff members 30, vehicles 50, and stations to provide the car sharing service.

The management server 100 comprises a communication device 101, a status information acquirer 104, a status updater 105, a management unit 106, a request acquirer 111, an information extractor 112, an allocation processing unit 113, a providing unit 114, a map application 115, a screen generating unit 116, and an output device 117. The management unit 106 includes a vehicle management unit 107, a staff management unit 108, a station management unit 109, and a user management unit 110.

The management server 100 includes a computer, and each of various functions of the management server 100 can be implemented by a circuit block, a memory, an LSI or the like in terms of hardware, and by a memory-loaded program or the like in terms of software. Accordingly, it will be obvious to those skilled in the art that the various functions of the management server 100 may be implemented in a variety of forms by hardware only, software only, or a combination thereof, and the form is not limited to any of them.

The communication device 101 connects to the network 2 to transmit or receive information necessary for the service to or from a communication device of a user terminal 12, a communication device of a staff terminal 32, and a communication device of a vehicle terminal 52. In the car sharing service, the communication device 101 receives position information transmitted from a user terminal 12, a staff terminal 32, and a vehicle terminal 52. Each of the user terminal 12, staff terminal 32, and vehicle terminal 52 measures its positron information and periodically transmits the position information to the management server 100. The status information acquirer 104 acquires the position information of the user terminal 12, staff terminal 32, and vehicle terminal 52 received by the communication device 101 and provides the position information to the status updater 105.

The communication device 101 also receives state information transmitted from a staff terminal 32 and a vehicle terminal 52. A staff member 30 inputs state information to the staff terminal 32, which then transmits the state information to the management server 100. Also, a user 10 or a staff member 30 inputs state information to the vehicle terminal 52, which then transmits the state information to the management server 100. The status information acquirer 104 acquires state information transmitted from the staff terminal 32 and the vehicle terminal 52 and provides the state information to the status updater 105.

The communication device 101 also receives, from the user terminal 12 of a user or the staff terminal 32 of a staff member who delivered a vehicle to the user, accompanying selection information that indicates whether or not the staff member rides together in the vehicle driven by the user. The communication device 101 may receive the accompanying selection information from the vehicle terminal 52 of the vehicle. As shown in Phase 2 in FIG. 2, after the staff member 30a delivers the vehicle 50 to the user 10, the staff member 30a will ride with the user 10 driving the vehicle 50 if the user 10 wishes the staff member 30a to ride together (ST4), and the staff member 30a will not ride with the user 10 driving the vehicle 50 if the user 10 does not wish the staff member 30a to ride together (ST5). At the time, the user 10 transmits the accompanying selection information from the user terminal 12 to the management server 100, or the staff member 30a transmits the accompanying selection information from the staff terminal 32 to the management server 100. The user 10 may transmit the accompanying selection information from the vehicle terminal 32 to the management server 100. The status information acquirer 104 then acquires the accompanying selection information received by the communication device 101 and provides the accompanying selection information to the status updater 105.

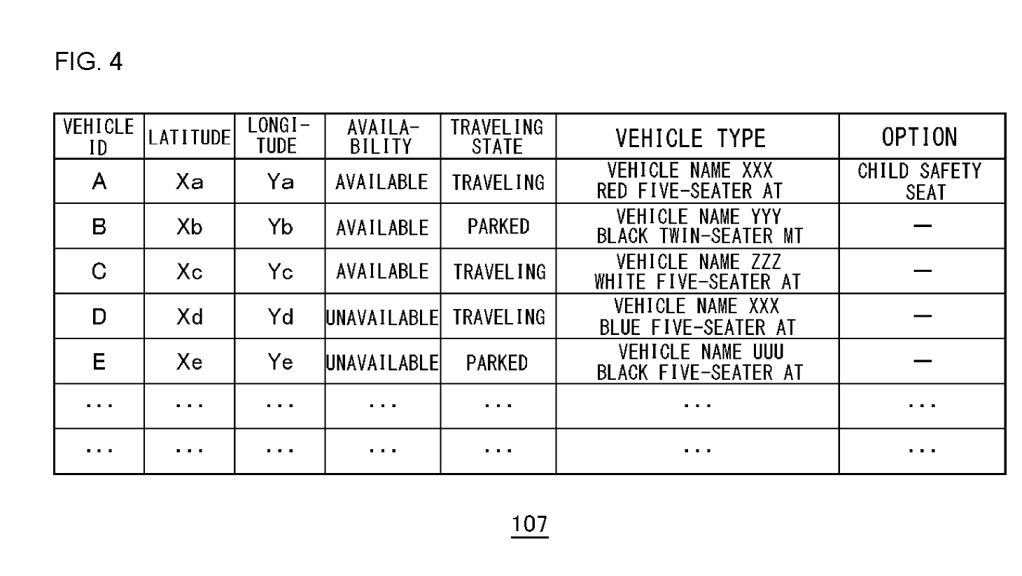

The status updater 105 updates the status information managed by the management unit 106, based on the position information, state information, and accompanying selection information acquired by the status information acquirer 104. The status updater 105 may suitably update the status information in real time so that the management unit 106 can record the latest status information. In the following, the status information managed by the management unit 106 will be described with reference to FIGS. 4-7. Although each of FIGS. 4-7 shows the status information recorded in the form of a table, the status information may be recorded in another form.

FIG. 4 shows a vehicle status table managed by the vehicle management unit 107. In the vehicle status table, position information including latitude and longitude, availability information indicating whether or not a vehicle is available, and traveling state information indicating the traveling state of a vehicle is recorded as status information related to a vehicle ID, which identifies a vehicle. In the vehicle status table shown in FIG. 4, information regarding the type of a vehicle (hereinafter, referred to as “vehicle type information”) and option information is also recorded as vehicle information related to a vehicle ID, but the vehicle information may be recorded in a vehicle master table, in which the make and specifications of a vehicle are registered, instead of in the vehicle status table, to be managed by the vehicle management unit 107.

The status updater 105 sequentially updates latitude and longitude in the vehicle status table, based on the position information periodically transmitted from a vehicle terminal 52. Accordingly, the vehicle management unit 107 manages the latest position information of the vehicle 50.

The availability information is information that indicates whether or not a vehicle can be used, and “available” means that the vehicle can be used, and “unavailable” means that the vehicle cannot be used. Being available means that the vehicle is in a standby state, so that a user 10 can select the vehicle on the user terminal 12, and being unavailable means that the vehicle has been already allocated to another user, so that a user 10 cannot select the vehicle on the user terminal 12. Therefore, when a user has selected a vehicle, the status updater 105 updates the availability information of the vehicle as “unavailable”. According to the availability information shown in FIG. 4, a user 10 can select the vehicles with the vehicle IDs A, B, and C, and cannot select the vehicles with the vehicle IDs D and E.

The traveling state information is information that indicates whether a vehicle is traveling or parked, and “traveling” means that the ignition switch of the vehicle is turned on, and “parked” means that the vehicle is parked in a station. Also, “traveling” may indicate the state where the engine or another power source of the vehicle is started and the vehicle can move. When a vehicle is traveling, the vehicle is driven by a user 10 or a staff member 30.

When the availability information is “available” and the traveling state information is “traveling”, the subject vehicle is in the same state as the vehicle 50 driven by the staff member 30a and waiting for a dispatch request (ST1 in FIG. 2). Also, when the availability information is “unavailable” and the traveling state information is “traveling”, the subject vehicle is in the same state as the vehicle 50 driven by the user 10 (ST4, ST5 in FIG. 2) or the vehicle 50 allocated to the user 10 and driven by the staff member 30a to the place where the user 10 is (ST3 in FIG. 2).

When the availability information is “available” and the traveling state information is “parked”, the subject vehicle is parked in a station and has not been allocated to anyone yet (ST9 in FIG. 2). Also, when the availability information is “unavailable” and the traveling state information is “parked”, the subject vehicle is parked in a station and has been already allocated to someone.

The vehicle type information shown in FIG. 4 includes the vehicle name, vehicle body color, seating capacity, and driving type (automatic transmission or manual transmission), and may also include information of the engine displacement, drive system, external sizes, a photographic image, and the likes. Also, the option information includes whether or not a child safety seat is provided, and may also include whether or not protective gear or a folding roof is provided. As mentioned previously, the vehicle information including the vehicle type information and option information may be recorded in the vehicle master table, instead of in the vehicle status table. A user 10 selects a desired vehicle based on the vehicle type information and/or the option information displayed on the user terminal 12.

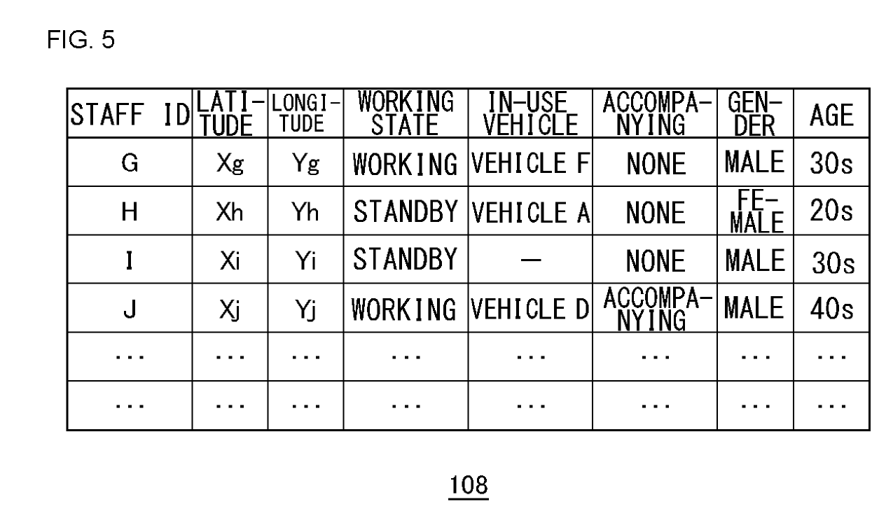

FIG. 5 shows a staff status table managed by the staff management unit 108. In the staff status table, position information including latitude and longitude, working state information indicating the working state of a staff member, in-use vehicle information indicating a vehicle in which a staff member is riding, and accompanying information indicating whether or not a staff member is riding with a user driving a vehicle is recorded as status information related to a staff ID, which identifies a staff member. In the staff status table shown in FIG. 5, the gender and age of a staff member are also recorded as attribute information related to a staff ID, but the attribute information may be recorded in a staff master table, instead of in the staff status table, so be managed by the staff management unit 108.

The status updater 105 sequentially updates latitude and longitude in the staff status table, based on the position information periodically transmitted from a staff terminal 32. Accordingly, the staff management unit 108 manages the latest position information of the staff member 30.

The working state information is information that indicates the working state of a staff member 30, and “working” means that the staff member 30 is working, and “standby” means that the staff member 30 is on standby. As the working state information, “break”, meaning that the staff member 30 is on a break, may also be set. Being working means that the staff member 30 is acting according to an instruction or a request from the management server 100 or a user 10, and being on standby means that the staff member 30 is waiting for an instruction or a request from the management server 100. Accordingly, both “working” and “standby” are set for a staff member 30 during business hours, and, when a staff member 30 of which the working state information is “standby” receives an instruction or a request, the working state information is updated as “working”, and the staff member 30 acts according to the instruction or request. When the staff member 30 completes the act according to the instruction or request, the working state information is updated as “standby”, and the staff member 30 waits for an instruction or a request again. In FIG. 2, for the staff member 30a, the working state information is set to “standby” in the states of ST1, ST5, and ST6, and set to “working” in the states of ST3 and ST4.

The in-use vehicle information indicates the

vehicle ID of a vehicle in which a staff member 30 is riding. For example, when getting into a vehicle 50, a staff member 30 inputs the staff ID of the staff member 30 to the vehicle terminal 52, which then transmits the staff ID thus input and the vehicle ID to the management server 100. Alternatively, when getting into a vehicle 50, a staff member 30 may input the vehicle ID to the staff terminal 32 of the staff member 30, and the staff terminal 32 then transmits the vehicle ID thus input and the staff ID to the management server 100. When the status information acquirer 104 acquires the combination of a staff ID and a vehicle ID thus transmitted, the status updater 105 updates the in-use vehicle information in the staff management unit 108. When the status information acquirer 104 acquires position information of a staff member 30 and position information of a vehicle 50 identical with each other, the status updater 105 may judge that the staff member 30 has gotten into the vehicle 50, so as to update the in-use vehicle information in the staff management unit 108. The in-use vehicle information is not set for the staff member of which the staff ID is I, which means that the staff member has gotten out of a vehicle 50 and is in the state of ST5.

The accompanying information is information that indicates whether or not a staff member 30 is riding with a user driving a vehicle, and “accompanying” means that the staff member 30 is riding together in the vehicle, and “none” means that the staff member 30 is not riding together. In Phase 2 shown in FIG. 2, when the status information acquirer 104 acquires the accompanying selection information indicating whether or not the staff member 30a rides together in the vehicle driven by the user 10, the status updater 105 updates the accompanying information of the staff member 30a. Accordingly, in FIG. 2, the accompanying information is set to “accompanying” in the case of ST4, and set to “none” in the other cases. When the user 10 arrives at the destination and gets out of the vehicle (ST6), the accompanying information is updated as “none”.

In the embodiment, a user 10 can select a vehicle based on the type of the vehicle, and a user 10 can also select a vehicle based on the staff member 30. For example, when the user 10 is a female and wishes a staff member 30 to ride together, the user 10 may gain a sense of safety if the staff member 30 is also a female. Accordingly, when the user 10 selects a vehicle, it may be suitable that the user 10 can refer to the attribute information of a staff member who will deliver the vehicle, so that the management server 100 transmits the attribute information of staff members, besides the vehicle information, to the user terminal 12 when the user selects a vehicle. The gender and age are examples of the attribute information, which may also include the name, a captured image of the face, or simple profile information of a staff member. As mentioned previously, the attribute information may be recorded in the staff master table, instead of in the staff status table.

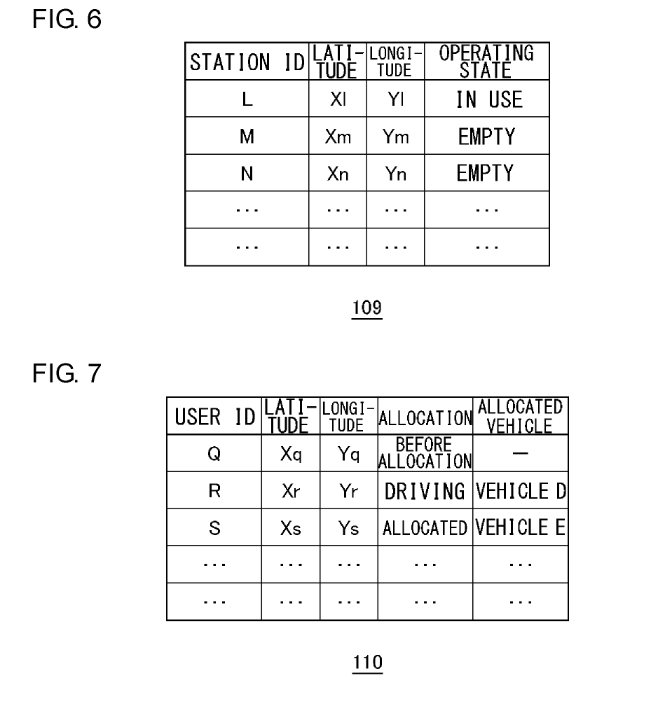

FIG. 6 shows a station status table managed by the station management unit 109. In the station status table, position information including latitude and longitude, and operating state information indicating the operating state of a station is recorded as status information related to a station ID, which identifies a station. Since a station does not move, the position information will be fixed values.

The operating state information is information that indicates the operating state of a station, and “in use” means that a vehicle is parked in the station, and “empty” means that no vehicle is parked in the station. When parking a vehicle 50 in a station, a user 10 inputs the station ID of the station to the vehicle terminal 52, which then transmits the station ID thus input and the vehicle ID to the management server 100. When the status information acquirer 104 acquires the combination of a station ID and a vehicle ID thus transmitted, the status updater 105 updates the traveling state information in the vehicle management unit 107 as “parked” and also updates the operating state information in the station management unit 109 as “in use”. When the status information acquirer 104 acquires position information of a vehicle 50 and position information of a station identical with each other, the status updater 105 may judge that the vehicle 50 has been parked in the station, so as to update the traveling state information in the vehicle management unit 107 and the operating state information in the station management unit 109. When updating the traveling state information in the vehicle management unit 107 as “parked”, the status updater 105 also updates the availability information as “available”.

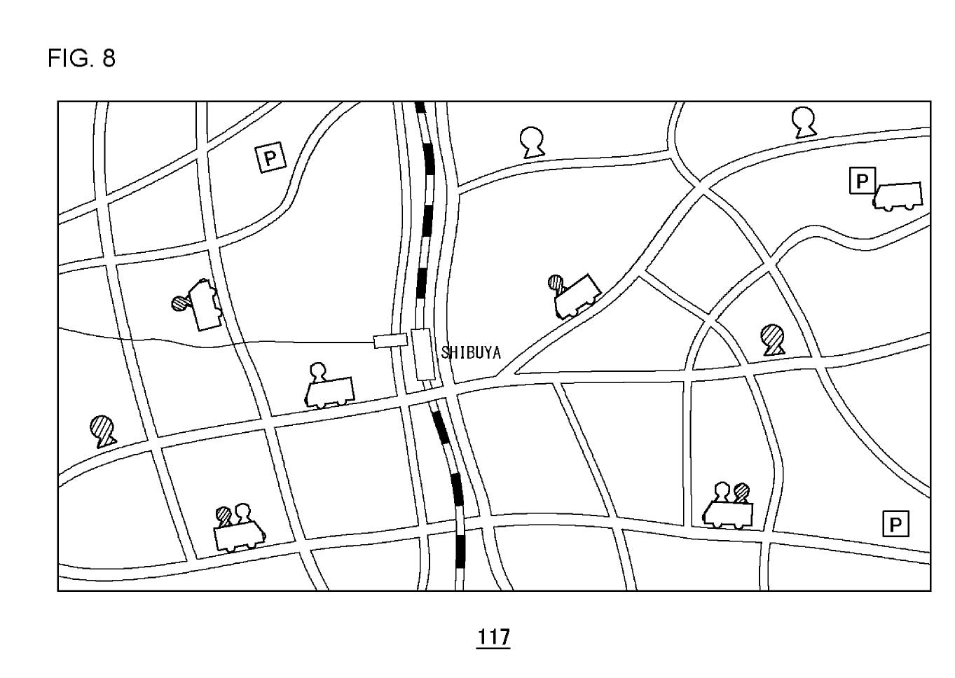

FIG. 7 shows a user status table managed by the

user management unit 110. In the user status table, position information including latitude and longitude, allocation information indicating a vehicle allocation state, and allocated vehicle information indicating a vehicle allocated to a user is recorded as status information related to a user ID, which identifies a user.

The status updater 105 sequentially updates latitude and longitude in the user status table, based on the position information periodically transmitted from a user terminal 12. Accordingly, the user management unit 110 manages the latest position information of the user 10.

The allocation information indicates a vehicle allocation state, and “before allocation” means that the user 10 has not been allocated a vehicle, “allocated” means that the user 10 has been allocated a vehicle but has not started driving, and “driving” means that the user 10 is driving a vehicle. When the user 10 starts the user application on the user terminal 12 and the status information acquirer 104 acquires the position information of the user 10, the status updater 10 5 sets the allocation information to “before allocation”.

The allocated vehicle information indicates a vehicle ID allocated to a user 10. When a user 10 operates the user terminal 12 and selects a vehicle, the user terminal 12 transmits a vehicle selection request to the management server 100. The selection request includes at least a user ID, a vehicle ID, and user position information. In the management server 100, when the request acquirer 111 acquires a selection request, the allocation processing unit 113 allocates a vehicle to the user 10 who has transmitted the selection request, based on the selection request. Accordingly, the allocation processing unit 113 updates the allocation information and the allocated vehicle information in the user status table. More specifically, based on the user ID and the vehicle ID included in the selection request, the allocation processing unit 113 updates the allocation information related to the corresponding user ID as “allocated” and writes the vehicle ID as the allocated vehicle information into the table. The allocation processing unit 113 also updates the latitude and longitude according to the user position information.

When the allocation processing unit 113 allocates a vehicle to the user, the providing unit 114 provides, to the user terminal 12, information indicating that vehicle allocation has been completed, and the providing unit 114 also provides a dispatch request to the vehicle terminal 52. Accordingly, the user 10 notices that the vehicle could have been selected, and the staff member 30 riding in the vehicle 50 notices that a dispatch request has been provided.

Thereafter, when the user 10 gets into the allocated vehicle, the status updater 105 updates the allocation information as “driving”. The fact that the user 10 has gotten into the vehicle may be input to one of the user terminal 12, staff terminal 32, and vehicle terminal 52, so as to be conveyed to the management server 100. Also, the fact that the user 10 has gotten out of the vehicle is input to the user terminal 12 or vehicle terminal 52, so as to be conveyed to the management server 100. When the status information acquirer 104 receives the notification of the user's getting off, the status updater 105 updates at least the availability information in the vehicle management unit 107 as “available”, and the allocation information as “before allocation” and the allocated vehicle information as “-(blank)” in the user management unit 110.

In the management server 100, the request acquirer 111 acquires, besides a vehicle selection request, a distribution request for requesting distribution of information referred to by a user to select a vehicle, from the user terminal 12. The request acquirer 111 also acquires from the staff terminal 32 a distribution request for requesting distribution of information used to check the service conditions.

When the request acquirer 111 acquires a distribution request from a user terminal 12, the information extractor 112 extracts, from the management unit 106, the status information of vehicles used for car sharing and the status information of staff members, and the providing unit 114 allows the communication device 101 to transmit the pieces of status information with the respective pieces of ID information to the user terminal 12. Also, when the request acquirer 111 acquires a distribution request from a staff terminal 32, the information extractor 112 extracts all the pieces of status information from the management unit 106, and the providing unit 114 allows the communication device 101 to transmit the pieces of status information with the respective pieces of ID information to the staff terminal 32. The handling of the distribution request will be described later.

The map application 115 is provided with status information managed in the management unit 106 and identifies the positions of vehicles, staff members, stations, and users, on the map data. The screen generating unit 116 generates data of a screen on which images of the vehicles, staff members, stations, and users are arranged at the identified positions, and provides the screen data to the output device 117. When a user and/or a staff member is riding in a vehicle, an image of the combination of the vehicle and the vehicle occupant(s) may be suitably arranged on the map data. The output device 117 is provided with a display, and displays thereon a map screen based on the screen data.

FIG. 8 shows an example of the map screen displayed on the output device 117. The status updater 105 updates the status information in real time; accordingly, the map screen is displayed so that images of traveling vehicles are moving thereon. An operator of the management server 100 views the map screen displayed on the output device 117 to check the position of a user who has not been allocated a vehicle, or the position of a staff member on standby.

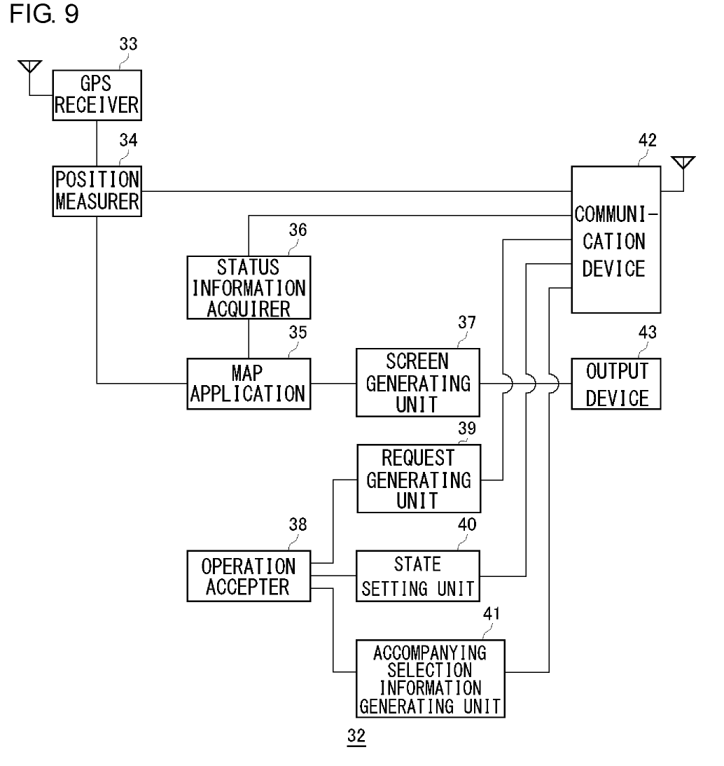

FIG. 9 is a functional block diagram of a staff terminal 32. The staff terminal 32 is possessed by a staff member 30 and accepts operation input from the staff member 30. The staff terminal 32 comprises a global positioning system (GPS) receiver 33, a position measurer 34, a map application 35, a status information acquirer 36, a screen generating unit 37, an operation accepter 38, a request generating unit 39, a state setting unit 40, an accompanying selection information generating unit 41, a communication device 42, and an output device 43. The output device 43 is provided with a display.

The staff terminal 32 includes a computer, and each of various functions of the staff terminal 32 can be implemented by a circuit block, a memory, an LSI or the like in terms of hardware, and by a memory-loaded program or the like in terms of software. Accordingly, it will be obvious to those skilled in the art that the various functions of the staff terminal 32 may be implemented in a variety of forms by hardware only, software only, or a combination thereof, and the form is not limited to any of them. Each function of the map application 35, status information acquirer 36, screen generating unit 37, request generating unit 39, state setting unit 40, and accompanying selection information generating unit 41 may be implemented by starting the staff application on the staff terminal 32.

On the staff terminal 32, which is a smartphone, an icon of the staff application is displayed on a menu screen of the output device 43. When the staff member 30 performs a selecting operation for the icon of the staff application, the operation accepter 38 accepts the selecting operation, and the staff application is started. When the staff application is started, the request generating unit 39 automatically generates a distribution request for requesting information indicating the service conditions and provides the distribution request to the communication device 42.

The GPS receiver 33 receives, via a GPS antenna, GPS signals transmitted from multiple GPS satellites. The position measurer 34 measures the current position of the staff terminal 32 based on a received GPS signal. More specifically, the position measurer 34 computes the latitude and longitude of the staff terminal 32, and the latitude and longitude constitute the position information of the terminal. The position measurer 34 periodically obtains the position information to provide it to the communication device 42. The position measurer 34 also provides the obtained position information to the map application 35.

The communication device 42 connects to the network 2 by wireless communication via a wireless base station or a wireless access point so as to transmit or receive information necessary for the service to or from the communication device 101 of the management server 100. When the staff application is started, the communication device 42 transmits the position information obtained by the position measurer 34 to the management server 100. The position measurer 34 periodically measures the position information, and the communication device 42 immediately transmits the measured position information to the management server 100. Accordingly, the staff management unit 108 of the management server 100 manages the latest position information of the staff member.

The communication device 42 also transmits a distribution request generated by the request generating unit 39 to the management server 100. Upon reception of the distribution request, the management server 100 distributes information indicating the service conditions to the staff terminal 32. If the management server 100 is configured so that the information extractor 112 extracts the status information each time the request acquirer 111 acquires a distribution request, the request generating unit 39 operates to periodically generate a distribution request. Accordingly, the staff terminal 32 can periodically acquire the information indicating the service conditions. If the management server 100 is configured so that, once the request acquirer 111 acquires a distribution request, the information extractor 112 periodically extracts the status information, the request generating unit 39 may generate a distribution request only once when the staff application is started.

Referring back to FIG. 3, in the management server 100, the information extractor 112 extracts pieces of status information, with the respective pieces of ID information, managed in the management unit 106. More specifically, the information extractor 112 extracts the status information of vehicles from the vehicle management unit 107, the status information of staff members from the staff management unit 108, the status information of stations from the station management unit 109, and the status information of users from the user management unit 110, with the respective pieces of ID information. Thus, the information extractor 112 extracts all pieces of status information managed in the management unit 106. The providing unit 114 then allows the communication device 101 to transmit, to the staff terminal 32, the extracted status information of the vehicles, staff members, stations, and users, with the respective pieces of ID information.

Referring back to FIG. 9, in the staff terminal 32, the status information acquirer 36 acquires the status information received by the communication device 42. The status information acquirer 36 then provides the status information thus acquired to the map application 35. Based on the status information, the map application 35 identifies the positions of vehicles, staff members, stations, and users, on the map data. The screen generating unit 37 generates data of a screen on which images of the vehicles, staff members, stations, and users are arranged at the identified positions, and provides the screen data to the output device 43. Based on the screen data, the output device 43 displays a map screen, on which the vehicles, staff members, stations, and users are arranged, on the display. The map application 35 may also identify the position of the staff terminal 32 on the map data, based on the position information provided by the position measurer 34. The map screen displayed on the display may be similar to that shown in FIG. 8.

The state setting unit 40 sets the state of the staff member 30 according to operation input accepted by the operation accepter 38 and allows the communication device 42 to transmit the information thus set to the management server 100. For example, when the staff member 30 gets into a vehicle 50 and inputs the vehicle ID of the vehicle 50 to the staff terminal 32, the state setting unit 40 allows the communication device 42 to transmit the staff ID and the vehicle ID, as driving start information, to the management server 100. Also, according to operation input accepted by the operation accepter 38, the accompanying selection information generating unit 41 generates accompanying selection information, indicating whether or not the staff member 30 rides together in the vehicle driven by the user, and allows the communication device 42 to transmit the accompanying selection information to the management server 100.

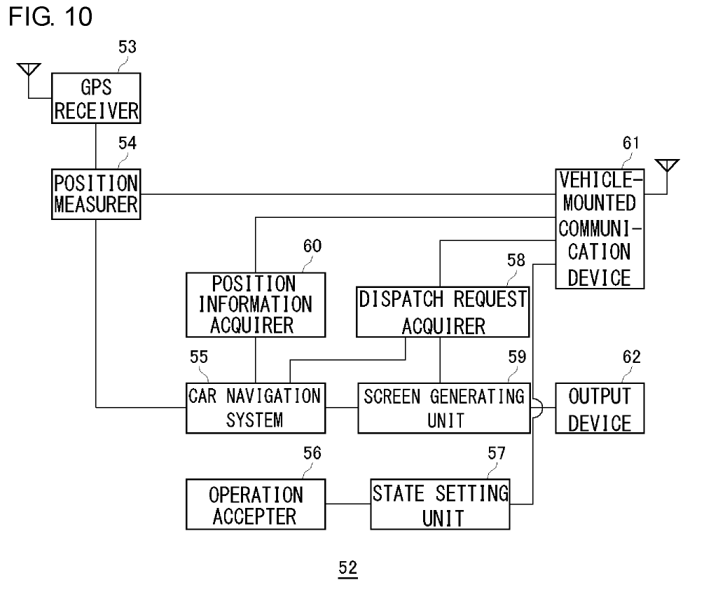

FIG. 10 is a functional block diagram of a vehicle terminal 52. The vehicle terminal 52 is mounted on a vehicle 50. The vehicle terminal 52 comprises a GPS receiver 53, a position measurer 54, a car navigation system 55, an operation accepter 56, a state setting unit 57, a dispatch request acquirer 58, a screen generating unit 59, a position information acquirer 60, a vehicle-mounted communication device 61, and an output device 62. The output device 62 is provided with a display.

The vehicle terminal 52 includes a computer, and each of various functions of the vehicle terminal 52 can be implemented by a circuit block, a memory, an LSI or the like in terms of hardware, and by a memory-loaded program or the like in terms of software. Accordingly, it will be obvious to those skilled in the art that the various functions of the vehicle terminal 52 may be implemented in a variety of forms by hardware only, software only, or a combination thereof, and the form is not limited to any of them.

The vehicle-mounted communication device 61 connects to the network 2 by wireless communication via a wireless base station or a wireless access point so as to transmit or receive information necessary for the service to or from the communication device 101 of the management server 100. The GPS receiver 53 receives, via a GPS antenna, GPS signals transmitted from multiple GPS satellites. The position measurer 54 measures the current position of the vehicle terminal 52 based on a received GPS signal. More specifically, the position measurer 54 computes the latitude and longitude of the vehicle terminal 52, and the latitude and longitude constitute the position information of the terminal. The position measurer 54 periodically obtains the position information to provide it to the vehicle-mounted communication device 61, which then periodically transmits the position information to the management server 100. The position measurer 54 also provides the obtained position information to the car navigation system 55.

Even when the ignition switch of the vehicle 50 is turned off, the functions of the GPS receiver 53, position measurer 54, and vehicle-mounted, communication device 61 may be suitably maintained in the active state so that the vehicle-mounted communication device 61 can still transmit the position information periodically to the management server 100.

The car navigation system 55 has map data and performs route guidance to a destination. Upon acquisition of a dispatch request from the management server 100, the dispatch request acquirer 58 provides the dispatch request to the car navigation system 55 and the screen generating unit 59. The dispatch request includes at least a user name and user position information.

The screen generating unit 59 then generates a message screen indicating that a dispatch request has been provided and displays the message screen on the display of the output device 62. The message screen includes a user name and user position information. By viewing the message screen, the staff member 30 driving the vehicle 50 notices that a dispatch request has been provided. Also, the output device 62 may have a sound output function and may notify the staff member 30 of a dispatch request with sound. The car navigation system 55 inputs the user position information included in the dispatch request as a destination, and the screen generating unit 59 displays a screen for route guidance to the destination on the output device 62. Accordingly, the staff member 30 driving the vehicle 50 will be guided to the place where the user is.

The operation accepter 56 accepts operation input from a staff member 30 or a user 10. When a staff member 30 starts driving, the operation accepter 56 accepts the staff ID, and the state setting unit 57 allows the vehicle-mounted communication device 61 to transmit the staff ID and the vehicle ID, as the driving start information, to the management server 100. Also, when a user 10 starts driving, the operation accepter 56 accepts the user ID, and the state setting unit 57 allows the vehicle-mounted communication device 61 to transmit the user ID and the vehicle ID, as the driving start information, to the management server 100. When the user 10 or staff member 30 finishes driving, the operation accepter 56 may accept the user ID or staff ID, and the state setting unit 57 may allow the vehicle-mounted communication device 61 to transmit the accepted ID and the vehicle ID, as driving finish information, to the management server 100. In the management server 100, when the status information acquirer 104 acquires such pieces of ID information, the status updater 105 updates the status information in the management unit 106.

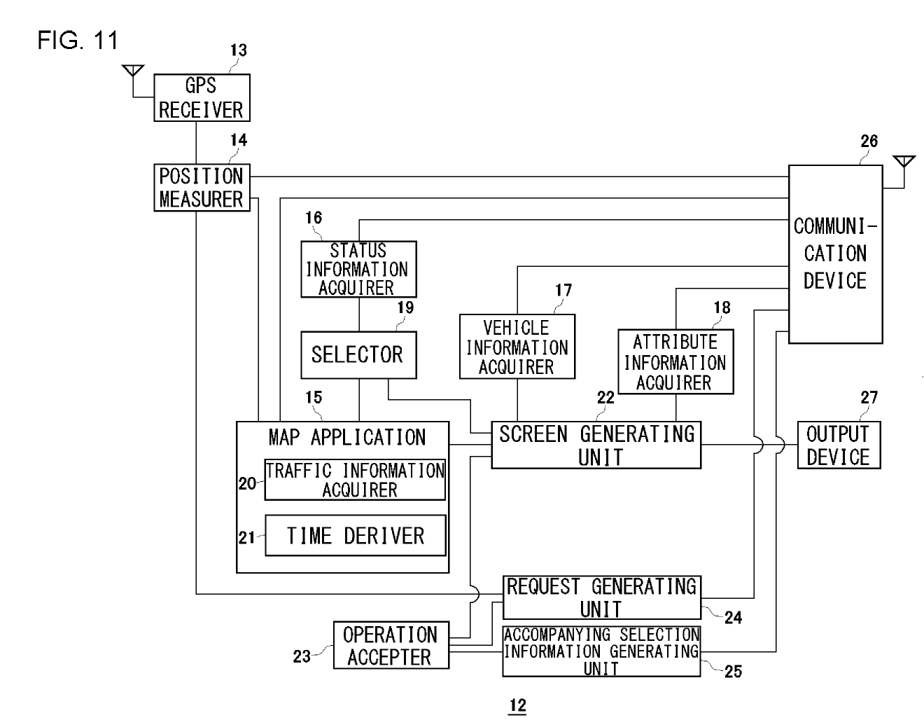

FIG. 11 is a functional block diagram of a user terminal 12, The user terminal 12 is possessed by a user 10 and accepts operation input from the user 10. The user terminal 12 comprises a GPS receiver 13, a position measurer 14, a map application 15, a status information acquirer 16, a vehicle information acquirer 17, an attribute information acquirer 18, a selector 19, a screen generating unit 22, an operation accepter 23, a request generating unit 24, an accompanying selection information generating unit 25, a communication device 26, and an output device 27. The output device 27 is provided with a display.

The user terminal 12 includes a computer, and each of various functions of the user terminal 12 can be implemented by a circuit block, a memory, an LSI or the like in terms of hardware, and by a memory-loaded program or the like in terms of software. Accordingly, it will be obvious to those skilled in the art that the various functions of the user terminal 12 may be implemented in a variety of forms by hardware only, software only, or a combination thereof, and the form is not limited to any of them. Each function of the map application 15, status information acquirer 16, vehicle information acquirer 17, attribute information acquirer 18, selector 19, screen generating unit 22, request generating unit 24, and accompanying selection information generating unit 25 may be implemented by starting the user application on the user terminal 12.

On the user terminal 12, which is a smartphone, an icon of the user application is displayed on a menu screen of the output device 27. When the user 10 performs a selecting operation for the icon of the user application, the operation accepter 23 accepts the selecting operation, and the user application is started. When the user application is started, the request generating unit 24 automatically generates a distribution request for requesting distribution of the status information of vehicles used for car sharing, the status information of staff members, the vehicle information, and the attribute information, and provides the distribution request to the communication device 26.

The GPS receiver 13 receives, via a GPS antenna, GPS signals transmitted from multiple GPS satellites. The position measurer 14 measures the current position of the user terminal 12 based on a received GPS signal. More specifically, the position measurer 14 computes the latitude and longitude of the user terminal 12, and the latitude and longitude constitute the position information of the terminal. The position measurer 14 periodically obtains the position information to provide it to the communication device 26. The position measurer 14 also provides the obtained position information to the map application 15 and the request generating unit 24.

The communication device 26 connects to the network 2 by wireless communication via a wireless base station or a wireless access point so as to transmit or receive information necessary for the service to or from the communication device 101 of the management server 100. When the user application is started, the communication device 26 transmits the position information obtained by the position measurer 14 to the management server 100. The position measurer 14 periodically measures the position information, and the communication device 26 immediately transmits the measured position information to the management server 100. Accordingly, the user management unit 110 of the management server 100 manages the latest position information of the user.

The communication device 26 also transmits a distribution request generated by the request generating unit 24 to the management server 100. Upon reception of the distribution request from the user terminal 12, the management server 100 distributes, to the user terminal 12, the status information of vehicles, the status information of staff members, the vehicle information including the vehicle type information and the option information, and the attribute information of staff members. The management server 100 may distribute the vehicle information and the attribute information to the user terminal 12 only once.

If the management server 100 is configured so that the information extractor 112 extracts the status information each time the request acquirer 111 acquires a distribution request, the request generating unit 24 operates to periodically generate a distribution request. Accordingly, the user terminal 12 can periodically acquire the latest status information. If the management server 100 is configured so that, once the request acquirer 111 acquires a distribution request, the information extractor 112 periodically extracts the status information, the request generating unit 24 may generate a distribution request only once when the user application is started.

Referring back to FIG. 3, the information extractor 112 extracts pieces of status information, with the respective pieces of ID information, managed in the management unit 106. More specifically, the information extractor 112 extracts the status information of all the vehicles with the vehicle ID information from, the vehicle management unit 107, and the status information of all the staff members with the staff ID information from the staff management unit 108. The providing unit 114 then allows the communication device 101 to transmit, to the user terminal 12, the extracted status information of the vehicles and staff members with the respective pieces of ID information.

The information extractor 112 also extracts, from the vehicle management unit 107, the vehicle information including the vehicle type information and the option information, with the vehicle ID information. Further, the information extractor 112 extracts, from the staff management unit 108, the attribute information of staff members including the gender information and the age information, with the staff ID information. The providing unit 114 then allows the communication device 101 to transmit, to the user terminal 12, the extracted vehicle information and staff attribute information with the respective pieces of ID information.

Referring back to FIG. 11, in the user terminal 12, the vehicle information acquirer 17 acquires the vehicle information received, by the communication device 26 and provides the vehicle information to the screen generating unit 22. Also, the attribute information acquirer 18 acquires the staff attribute information received by the communication device 26 and provides the staff attribute information to the screen generating unit 22.

The status information acquirer 16 acquires the status information of vehicles and. the status information of staff members received by the communication device 26. The status information acquirer 16 then provides the status information thus acquired to the selector 19. Accordingly, the selector 19 selects vehicles of which the availability information is set to “available” in the vehicle status information and provides the position information related to the corresponding vehicle IDs to the map application 15. For example, with regard to the vehicles with the vehicle IDs A-E shown in FIG. 4, the selector 19 selects the vehicles with the vehicle IDs A, B, and C, and does not select the vehicles with the vehicle IDs D and E.

Namely, the selector 19 performs processing for selecting vehicles available for the user, from among all the vehicles. Upon identifying the vehicle IDs of vehicles available for the user, the selector 19 provides the position information related to the identified vehicle IDs to the map application 15. Based on the position information thus provided, the map application 15 identifies the positions of the available vehicles on the map data. Accordingly, the screen generating unit 22 generates data of a screen on which images of the vehicles are arranged at the identified positions.

The selector 19 also selects staff members of which the working state information is set to “standby” in the staff status information and provides the in-use vehicle information of the selected staff members together with the staff IDs to the screen generating unit 22.

The map application 15 of the embodiment includes a traffic information acquirer 20 and a time deriver 21. The traffic information acquirer 20 acquires traffic congestion information and regulation information within the service area. The time deriver 21 derives the time required before the user 10 can get into the vehicle, based on the current position (X, Y) of the user terminal 12 measured by the position measurer 14 and the position information of the vehicle acquired by the status information acquirer 16.

With regard to the vehicle status information shown in FIG. 4, the selector 19 selects the vehicles with the vehicle IDs A, B, and C as vehicles available for the user 10. Among the selected vehicles, the vehicles with the vehicle IDs A and C have the traveling state information of “traveling”, which means that staff members 30 are driving the vehicles. Meanwhile, the vehicle with the vehicle ID B has the traveling state information of “parked”, which means that the vehicle is parked in a station.

The time deriver 21 separately computes the time required before the user 10 can get into a vehicle of which the traveling state information is “traveling”, and the time required before the user 10 can get into a vehicle of which the traveling state information is “parked”. Since a “traveling” vehicle is driven by a staff member 30 to be delivered to the user 10, the time deriver 21 computes an arrival time required before the vehicle arrives at the user's position, as the time required before the user 10 can get into the vehicle. Based on the current position (X, Y) of the user terminal 12 and the position information of the “traveling” vehicle, the time deriver 21 derives the distance of the route to compute the arrival time of the vehicle, suitably in consideration of traffic information acquired by the traffic information acquirer 20. By considering the traffic information, a more accurate arrival time can be computed. In this way, the time deriver 21 computes the arrival time of each of the “traveling” vehicles.

Meanwhile, since a “parked” vehicle can be used when the user 10 walks to the station, the time deriver 21 computes a walking time required for the user 10 to walk over to the station, as the time required before the user 10 can get into the vehicle. Accordingly, the time deriver 21 derives the user's walking time based on the current position (X, Y) of the user terminal 12, the position information of the “parked” vehicle, and the walking distance to the station.

With regard to an API used for estimation of a vehicle traveling time and a walking time between two points using map data, various APIs have been already put into practical use, and the time deriver 21 may use a conventional API for estimation to compute the arrival time of a vehicle and the walking time of a user. The time deriver 21 computes the vehicle arrival time or the user's walking time with respect to each of the available vehicles and provides the computed time with the vehicle ID information to the screen generating unit 22.

The screen generating unit 22 generates an initial screen data including information regarding a vehicle of which the arrival time is shortest, and displays the initial screen on the output device 27.

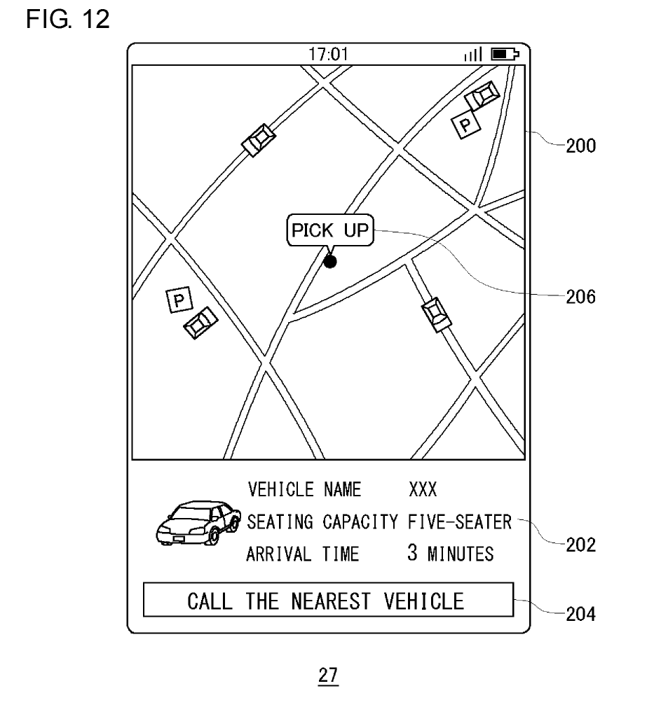

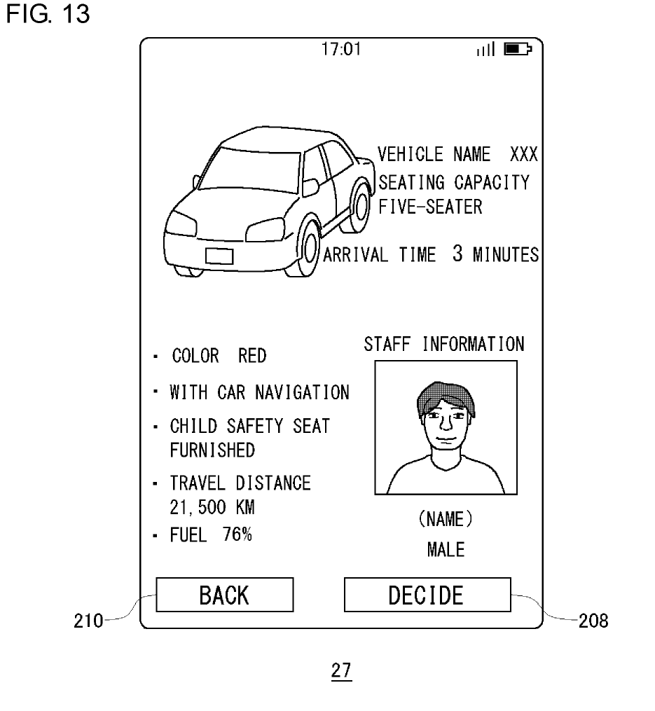

FIG. 12 shows an example of the initial screen displayed on the output device 27. The screen generating unit 22 displays a map screen 200 generated by the map application 15 on the display. On the map screen 200, available vehicles are displayed, and a traveling vehicle moves with time in the screen. In the initial screen, the user's position is set at the center of the map screen. The display of the embodiment comprises a touch screen, so that the user 10 can enlarge or reduce the map screen with a pinch-out or pinch-in operation on the map screen and can also scroll the map screen with a sliding operation. The operation accepter 23 accepts a finger operation by the user 10 and provides an instruction for changing the map screen to the screen generating unit 22. In the map screen 200, a vehicle with the “P” mark is a vehicle parked in a station. By viewing the map screen, the user 10 can check the situations of free vehicles around the user 10.

The screen generating unit 22 provides a vehicle information presenting screen 202, which includes information regarding the type of the vehicle of which the arrival time is shortest, below the map screen 200. The screen generating unit 22 acquires, from the time deriver 21, the vehicle arrival time or the user's walking time with respect to each vehicle available for the user 10. From among the multiple vehicles of which the arrival times have been computed, the screen generating unit 22 extracts a vehicle with the shortest arrival time and displays the vehicle information identified by the vehicle ID of the vehicle on the vehicle information presenting screen 202. In the example shown in FIG. 12, as the vehicle information, the vehicle name and the seating capacity are displayed, and a photographic image of the vehicle with the vehicle name XXX is also displayed. The photographic image may suitably be an image of the vehicle of which the body color is that related to the vehicle ID. Accordingly, the user 10 can check the vehicle type information of the vehicle that can arrive in the shortest time.

In the car sharing system 1 of the embodiment, since users 10 themselves drive vehicles, the body color of the vehicle could be a factor in decision making when the user 10 selects a vehicle. For example, if a user 10 feels like driving a red vehicle, the user 10 will wish to check the color of the vehicle to select. Therefore, the photographic image may suitably be an image of the vehicle of which the body color is the same as that of the available vehicle.

When the user 10 operates a selection button 204, the operation accepter 23 accepts the operation of the selection button 204. When the operation accepter 23 accepts the operation of the selection button 204, the request generating unit 24 generates a selection request including the vehicle ID of the vehicle, i.e., the vehicle with the vehicle name XXX that will arrive in three minutes, the user ID, and the user position information. The selection request thus generated is transmitted from the communication device 26 to the management server 100.

As the specification of the user interface, after the operation accepter 23 accepts the operation of the selection button 204, a check screen may be provided to the user 10. In this case, upon accepting the operation of the selection button 204, the operation accepter 23 instructs the screen generating unit 22 to generate a check screen for the selected vehicle.

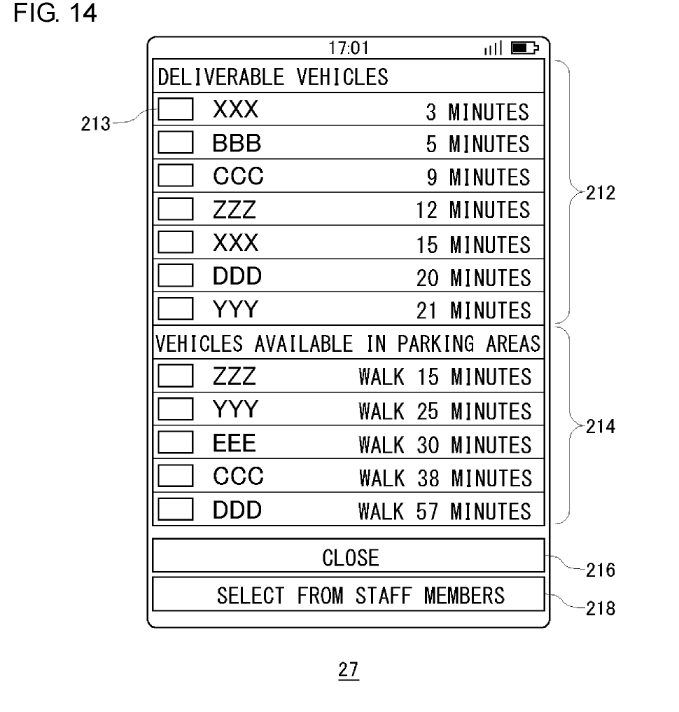

FIG. 13 shows an example of a vehicle check screen displayed on the output device 27. The screen generating unit 22 displays the vehicle information and the staff information on the display. As stated previously, the screen generating unit 22 acquires the in-use vehicle information of “standby” staff members from the selector 19 and also acquires the staff attribute information from the attribute information acquirer 18. Accordingly, the screen generating unit 22 identifies a staff ID to which the vehicle ID of the vehicle selected by the user 10 is related as the in-use vehicle information, and displays the attribute information related to the identified staff ID on the vehicle check screen. In the example shown in FIG. 13, the name, the gender, and a photographic image of the staff member are displayed as the attribute information. Further, the age information and profile information may also be displayed.

The car sharing system 1 of the embodiment provides the use mode in which a staff member 30 rides together in a vehicle driven by a user 10. When the user 10 is a female, for example, the user 10 may wish a female staff member 30 to ride together. Accordingly, if the gender of the staff member 30 is displayed on the vehicle check screen, the user 10 can make a final check before calling the selected vehicle. When the user 10 operates a decision button 208, the operation accepter 23 accepts the operation of the decision button 208, and the request generating unit 24 generates a selection request including the vehicle ID of the vehicle, the user ID, and the user position information. The selection request thus generated is transmitted from the communication device 26 to the management server 100. When the user 10 operates a back button 210, the operation accepter 23 accepts the operation of the back button 210 and instructs the screen generating unit 22 to display the previously-displayed screen, i.e., the screen shown in FIG. 12.

On the user position at the center of the map screen shown in FIG. 12, a list display button 206 is set. The list display button 206 is a button used to display a list of available vehicles. When the user 10 operates the list display button 206, the operation accepter 23 accepts the operation of the list display button 206 and instructs the screen generating unit 22 to generate a vehicle list screen.

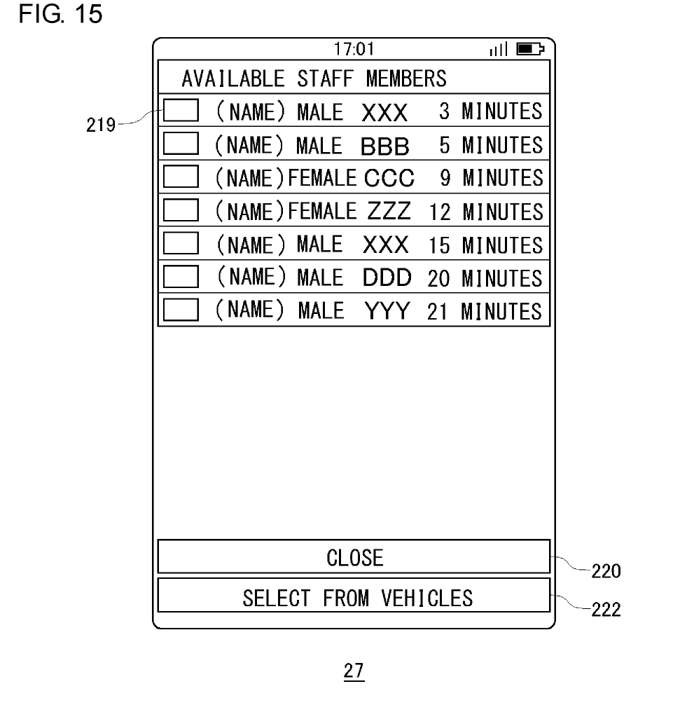

FIG. 14 shows an example of a vehicle list screen displayed on the output device 27. The screen generating unit 22 displays a list of available vehicles on the display. At the time, the screen generating unit 22 displays, on the display, a list in which vehicles that can be delivered and vehicles that can be driven from parking areas (stations) are separated. The screen generating unit 22 divides the vehicle list screen into two screens of a deliverable vehicle list screen 212 and a parked vehicle list screen 214. By separating the screens in this way, the user 10 can easily discriminate between the vehicles that can be called and the vehicles that can be used when the user walks to the stations. On the left side of the screen, photographic images 213 of the vehicles are displayed.

The deliverable vehicle list screen 212 is a screen for displaying a list of deliverable vehicles, i.e., vehicles that can be called by the user 10. The screen generating unit 22 acquires, from the time deriver 21, the vehicle arrival time or the user's walking time with respect to each of the available vehicles. The screen generating unit 22 then displays pieces of information regarding the types of the multiple vehicles of which the arrival times have been computed, in order of increasing vehicle arrival time from the top to the bottom in the deliverable vehicle list screen 212. In the vehicle list screen shown in FIG. 14, the information regarding the type of the vehicle is the vehicle name. The screen generating unit 22 displays the information regarding the type of a vehicle, related to the arrival time required before the vehicle arrives at the user's position; in this example, the information regarding the type of the vehicle is displayed side by side with the arrival time.

In the deliverable vehicle list screen 212, the display area of the vehicle type information and the vehicle arrival times is sectioned for each vehicle. Since multiple pieces of vehicle type information and vehicle arrival times are displayed in order of increasing vehicle arrival time from the top, the user 10 can easily check the arrival time of each vehicle. Thus, a list of multiple pieces of vehicle type information and vehicle arrival times is displayed, so that the user 10 can select a desired type of vehicle in consideration of the arrival time. When the user 10 selects the display area of a desired vehicle, the operation accepter 23 accepts the vehicle selecting operation, and the request generating unit 24 generates a selection request including the vehicle ID of the selected vehicle, the user ID, and the user position information. The selection request thus generated is transmitted from the communication device 26 to the management server 100.

The screen generating unit 22 may display a list of the shortest arrival time for each vehicle type on the display. In the example shown in FIG. 14, the two vehicles with the vehicle name XXX, as the vehicle type information, are displayed on the deliverable vehicle list screen 212; however, the screen may be provided so that only the information of the vehicle with the vehicle name XXX that will arrive in three minutes is displayed, and the information of the vehicle with the vehicle name XXX that will arrive in fifteen minutes is not displayed. When selecting a vehicle based on the vehicle name, the user 10 may often wish to know the information of the vehicle that will arrive earlier, so that the screen generating unit 22 may provide the list that does not include the information of a vehicle of the same type that will arrive later.

The parked vehicle list screen 214 is a screen for displaying a list of vehicles that can be driven from the stations. The screen generating unit 22 displays pieces of information regarding the types of the multiple vehicles for which the user's walking times have been computed, in order of increasing user's walking time from the top to the bottom in the parked vehicle list screen 214. The screen generating unit 22 displays the information regarding the type of a vehicle, related to the walking time required for the user to walk over to the station.

Also in the parked vehicle list screen 214, the display area of the vehicle type information and the user's walking times is sectioned for each vehicle. Since multiple pieces of vehicle type information and walking times are displayed in order of increasing walking time from the top, the user 10 can easily check the walking time for each vehicle. Thus, a list of multiple pieces of vehicle type information and walking times is displayed, so that the user 10 can select a desired type of vehicle in consideration of the walking time. When the user 10 selects the display area of a desired vehicle, the operation accepter 23 accepts the vehicle selecting operation, and the request generating unit 24 generates a selection request including the vehicle ID of the selected vehicle, the user ID, and the user position information. The selection request thus generated is transmitted from the communication device 26 to the management server 100.

Upon accepting the vehicle selecting operation on the vehicle list screen, the operation accepter 23 may instruct the screen generating unit 22 to generate a check screen for the selected vehicle. In this case, the vehicle check screen as shown in FIG. 13 will be displayed on the display.

When the user 10 operates a close button 216 on the vehicle list screen, the operation accepter 23 accepts the operation of the close button 216 and instructs the screen generating unit 22 to display the initial screen, i.e., the screen shown in FIG. 12.

A transition button 218 displayed at the bottom is a button used to display a list of staff members who can deliver the vehicles. When the user 10 operates the transition button 218, the operation accepter 23 accepts the operation of the transition button 218 and instructs the screen generating unit 22 to generate a staff list screen.

FIG. 15 shows an example of a staff list screen displayed on the output device 27. The screen generating unit 22 displays, as a list on the display, the attribute information of a staff member who can deliver a vehicle to the user, and the arrival time required before the vehicle arrives at the user's position. The screen generating unit 22 acquires the in-use vehicle information of “standby” staff members from the selector 19. Accordingly, the screen generating unit 22 displays the staff attribute information in the place where the vehicle type information is displayed in the deliverable vehicle list screen 212 in FIG. 14, in the same order of vehicles as shown in the deliverable vehicle list screen 212. Namely, the screen generating unit 22 displays staff attribute information related to the arrival time required before the vehicle arrives at the user's position, and displays pieces of staff information and vehicle arrival times in order of increasing vehicle arrival time from the top to the bottom in the screen. Thus, a list of pieces of staff information and vehicle arrival times is displayed, so that the user 10 can select a staff member in consideration of the arrival time. On the left side of the screen, photographic images 219 of the staff members are displayed. Although the vehicle names are also displayed in the example shown in FIG. 15, the vehicle names need not necessarily be displayed.

When the user 10 selects the display area of a desired staff member, the operation accepter 23 accepts the selecting operation for the vehicle driven by the available staff member, and the request generating unit 24 generates a selection request including the vehicle ID of the selected vehicle, the user ID, arid the user position information. The selection request thus generated is transmitted from the communication device 26 to the management server 100. Upon accepting the vehicle selecting operation on the staff list screen, the operation accepter 23 may instruct the screen generating unit 22 to generate a check screen for the selected vehicle. In this case, the vehicle check screen as shown in FIG. 13 will be displayed on the display.

When the user 10 operates a close button 220 on the staff list screen, the operation accepter 23 accepts the operation of the close button 220 and instructs the screen generating unit 22 to display the initial screen, i.e., the screen shown in FIG. 12.

A transition button 222 displayed at the bottom is a button used to display a list of deliverable vehicles. When the user 10 operates the transition button 222, the operation accepter 23 accepts the operation of the transition button 222 and instructs the screen generating unit 22 to generate the vehicle list screen as shown in FIG. 14.

In the car sharing system 1, since vehicles 50 and users 10 move, the vehicle arrival times and the user's walking times change by the minute. Accordingly, the time deriver 21 may suitably derive the time required before the user can get into a vehicle with a predetermined period, and the screen generating unit 22 may suitably reflect the derived time in the screen in real time. Therefore, the user 10 can check accurate vehicle arrival times and walking times. Also, by deriving the times on the user terminal 12 side, the load on the management server 100 can be reduced compared to the case of deriving the times on the management server 100 side.

On the vehicle list screen shown in FIG. 14, the vehicle type information of all the vehicles available for the user may be displayed together with the vehicle arrival times or the user's walking times; however, when the user 10 selects a vehicle and the management server 100 allocates the vehicle to the user 10, the vehicle cannot be allocated to another user until the user 10 finishes using the vehicle. For example, if the user 10 selects a vehicle of which the time for delivery to the user 10 is two hours, the vehicle cannot be allocated to another user at least for two hours, so that the operation efficiency of the service will be reduced.

Accordingly, the screen generating unit 22 may display only the information regarding the types of vehicles of which use can be started by the user 10 within a predetermined period of time, in consideration of the position of the user 10. More specifically, the screen generating unit 22 does not include, in the vehicle list screen, the information regarding the type of a vehicle of which the arrival time exceeds a first predetermined time, and the information regarding the type of a vehicle for which the user's walking time exceeds a second predetermined time. Accordingly, the user 10 cannot select a vehicle for which a long time is required until the user can get into the vehicle, so that the operation efficiency of the service can be improved. The first predetermined time may be suitably the second predetermined time or less.

Also, the screen generating unit 22 may determine whether or not to display the vehicle type information based on the distance between the vehicle and the user, instead of based on the time. Namely, the screen generating unit 22 may display only the information regarding the types of vehicles positioned within a predetermined distance from the position of the user 10. More specifically, the screen generating unit 22 does not include, in the vehicle list screen, the information regarding the type of a “traveling” vehicle of which the distance from the user on the route exceeds a first predetermined distance, and the information regarding the type of a “parked” vehicle of which the distance from the user on the route exceeds a second predetermined distance. Accordingly, the user 10 cannot select a vehicle for which a long time is required until the user can get into the vehicle, so that the operation efficiency of the service can be improved.

The processing stated above may be performed on the management server 100 side. Namely, according to a distribution request from the user terminal 12, the information extractor 112 in the management server 100 extracts the status information of vehicles of which use can be started by the user 10 within a predetermined period of time, or the status information of available vehicles positioned within a predetermined distance from the position of the user 10, instead of the status information of all the vehicles. Accordingly, the screen generating unit 22 in the user terminal 12 can generate the vehicle list screen without considering the time required before the user 10 can get into the vehicle or the distance from the user 10.

Further, the screen generating processing by the screen generating unit 22 may also be performed on the management server 100 side. Namely, the data of the screens shown in FIGS. 12-15 may be generated on the management server 100 side and transmitted to the user terminal 12 so that the user terminal 12 can display the screen data on the output device 27.

As described above, the user 10 transmits a vehicle selection request from the user terminal 12 to the management server 100. In the management server 100, when the request acquirer 111 acquires a selection request, the allocation processing unit 113 allocates a vehicle to the user 10 who has transmitted the selection request, based on the selection request. When the allocation processing unit 113 allocates a vehicle to the user, the providing unit 114 provides, to the user terminal 12, information indicating that vehicle allocation has been completed. Accordingly, the user 10 notices that the vehicle could have been selected. When the user 10 has selected a parked vehicle, the user 10 walks to the station where the vehicle is parked so as to use the vehicle. In the following, there will be described the operations of each terminal in the use mode in which the user 10 has selected a vehicle to be delivered.

The providing unit 114 provides a dispatch request to the vehicle terminal 52. When the dispatch request acquirer 58 in the vehicle terminal 52 acquires the dispatch request, the screen generating unit 59 generates a message screen indicating that a dispatch request has been provided, and displays the message screen on the display of the output device 62. The message screen includes a user name and user position information. By viewing the message screen, the staff member 30 driving the vehicle 50 notices that a dispatch request has been provided. The providing unit 114 may provide the dispatch request to the staff terminal 32 of the staff member 30 who delivers the vehicle 50 to the user 10. In this case, the screen generating unit 37 in the staff terminal 32 generates the message screen indicating that the dispatch request has been provided, and displays the message screen on the display of the output device 43.

The staff member 30 drives the vehicle 50 to the position where the user 10 is waiting. When the staff member 30 has delivered the vehicle 50 to the user 10, the staff member 30 gets out of the driver's side, and the user 10 gets in the driver's side instead. At the time, the user 10 tells the staff member 30 whether or not the user 10 wishes the staff member 30 to ride together. If the user 10 wishes the staff member 30 to ride together, the staff member 30 will get in the backseat or the passenger seat of the vehicle 50. The user 10 then operates the user terminal 12 to input thereto whether or not the staff member 30 will ride together. When the operation accepter 23 accepts the operation input, the accompanying selection information generating unit 25 generates the accompanying selection information indicating whether or not the staff member 30 rides together, and the communication device 26 transmits the accompanying selection information to the management server 100. The accompanying selection information includes the staff ID of the staff member 30.

The accompanying selection information may be transmitted from the staff terminal 32 to the management server 100. In this case, when the user 10 tells whether or not the user 10 wishes the staff member 30 to ride together, the staff member 30 operates the staff terminal 32 to input thereto whether or not the staff member 30 will ride together. When the operation accepter 38 accepts the operation input, the accompanying selection information generating unit 41 generates the accompanying selection information indicating whether or not the staff member 30 rides together, and the communication device 42 transmits the accompanying selection information to the management server 100.

The user 10 may input, to the user terminal 12, whether or not the user 10 wishes a staff member 30 to ride together when the user 10 selects an available vehicle. In this case, the accompanying selection information is transmitted together with the vehicle selection request to the management server 100.

The status information acquirer 104 in the management server 100 acquires the accompanying selection information from the user terminal 12 or the staff terminal 32. The status updater 105 then updates the status information of the staff member 30 identified by the staff ID included in the accompanying selection information.

Based on the accompanying selection information acquired by the status information acquirer 104, the staff management unit 108 records status information indicating whether or not the staff member 30 is riding with the user 10 driving the vehicle 50. This status information corresponds to the accompanying information in the staff status table shown in FIG. 5. When the status information acquirer 104 acquires the accompanying selection information indicating that the staff member 30 rides together, the staff management unit 108 records the accompanying information indicating that the staff member 30 is riding together. On the other hand, when the status information acquirer 104 acquires the accompanying selection information indicating that the staff member 30 does not ride together, the staff management unit 108 records the accompanying information indicating that the staff member 30 is not riding together. This recording process is performed by the status updater 105. Thus, the staff management unit 108 records the accompanying information according to the accompanying selection information, so that the management server 100 can appropriately manage the state of the staff member 30.

The staff management unit 108 also records status information indicating whether or not the staff member 30 is working after delivering the vehicle 50 to the user 10, based on the accompanying selection information. This status information corresponds to the working state information in the staff status table shown in FIG. 5. When the status information acquirer 104 acquires the accompanying selection information indicating that the staff member 30 rides together, the staff management unit 108 records the working state information indicating that the staff member 30 is working. On the other hand, when the status information acquirer 104 acquires the accompanying selection information indicating that the staff member 30 does not ride together, the staff management unit 108 records the working state information indicating that the staff member 30 is not working, i.e., the staff member 30 is on standby in the embodiment. This recording process is performed by the status updater 105.

Thus, the staff management unit 108 records the

working state information according to the accompanying selection information, so that the management server 100 can appropriately manage the car sharing service. In the embodiment, a staff member 30 who is not riding with a user becomes a returning destination candidate to whom a vehicle driven by another user may be returned. Accordingly, when a staff member 30 is not riding with a user, the working state information of the staff member 30 may be suitably set to “standby” promptly so that another user can specify the staff member 30 as the returning destination. Meanwhile, a staff member 30 riding with a user should not be available for another user, and the working state information of the staff member 30 needs to be maintained to “working”. In the embodiment, the status updater 105 sets the working state information according to the accompanying selection information, thereby efficiently operating the car sharing service.

When the staff member 30 is not riding together in the vehicle 50 driven by the user 10, the providing unit 114 provides the position information of a place where the vehicle can be parked, to the vehicle terminal 52 of the vehicle 50. The information extractor 112 extracts the position information of a station of which the operating state information is set to “empty” in the station management unit 109, and the providing unit 114 allows the communication device 101 to transmit the position information to the vehicle terminal 52. The position information acquirer 60 in the vehicle terminal 52 then acquires the position information of the “empty” station and provides the position information to the car navigation system 55. Accordingly, the car navigation system 55 sets the position information of the “empty” station on the map data, and the screen generating unit 59 arranges an empty station mark at the position. Thus, on the map screen displayed on the output device 62, the empty station marks will be displayed.

When the staff member 30 is not riding with the user 10, the user 10 needs to park the vehicle 50 in an empty station (ST9 in FIG. 2). Since the marks indicating the positions of empty stations are displayed in the map screen on the output device 62 of the vehicle terminal 52, the user 10 can easily find a station around the destination.

When the staff member 30 is riding with the user 10, since the user 10 need not return the vehicle 50 to a station, the management server 100 need not provide the position information of an “empty” station to the vehicle terminal 52.

Also, when the staff member 30 is not riding together in the vehicle 50 driven by the user 10, the providing unit 114 provides the position information of a staff member of which the status information indicates that the staff member is not riding in any vehicle and is not working, to the vehicle terminal 52 of the vehicle 50. The information extractor 112 extracts the position information of a staff member of which the working state information is set to “standby” and of which the in-use vehicle information is blank in the staff management unit 108, and the providing unit 114 allows the communication device 101 to transmit the position information to the vehicle terminal 52. The position information acquirer 60 in the vehicle terminal 52 then acquires the position information of the staff member and provides the position information to the car navigation system 55. Accordingly, the car navigation system 55 sets the position information of the staff member on the map data, and the screen generating unit 59 arranges a staff mark at the position. Thus, on the map screen displayed on the output device 62, the marks of available staff members will be displayed.

When the staff member 30 is not riding with the user 10, the user 10 needs to return the vehicle 50 to a standby staff member who is not riding in any vehicle (ST7 in FIG. 2). Since the marks indicating the positions of staff members are displayed in the map screen on the output device 62 of the vehicle terminal 52, the user 10 can easily find a standby staff member around the destination.

When the staff member 30 is riding with the user 10, since the user 10 need not return the vehicle 50 to a staff member, the management server 100 need not provide the position information of a staff member to the vehicle terminal 52.

The disclosure has been described with reference to an embodiment. The embodiment is intended to be illustrative only, and it will be obvious to those skilled in the art that various combinations of constituting elements or processes could be developed and that such combinations also fall within the scope of the present disclosure. The embodiment describes the case where the user terminal 12 or the staff terminal 32 transmits the accompanying selection information; however, the vehicle terminal 52 may comprise an accompanying selection information generating unit and may transmit the accompanying selection information.

The embodiment describes the case where the screen generating unit 22 of the user terminal 12 displays the screens shown in FIGS. 12-15 on the output device 27, as screen interfaces used when a user selects a vehicle. These screen interfaces can also be suitably used in other vehicle dispatch systems, such as a system for taxi arrangement, besides the car sharing system 1. If the screen interfaces are used in a taxi dispatch system, since users 10 do not get into taxies in parking areas, the parked vehicle list screen 214 shown in FIG. 14 will not be used.

What is claimed is:

1. An information processing system, comprising:
a user terminal, possessed by a user;
a vehicle terminal mounted on a vehicle; and
a management server capable of communicating with the user terminal and the vehicle terminal,
the management server including:
a management unit configured to manage status information, which includes availability information indicating whether or not a vehicle is available and position information of a vehicle, and information regarding the type of a vehicle;
an information extractor configured to extract, from the management unit, status information of a vehicle and information regarding the type of a vehicle; and
a providing unit configured to provide information extracted by the information extractor to the user terminal,
the user terminal including:
an information acquirer configured to acquire provided information;
a position measurer configured to measure the current position of the user terminal; and
a screen generating unit configured to display, as a list on a display, information regarding the type of an available vehicle, and an arrival time required before the vehicle arrives at the user's position.

2. The information processing system of claim 1, wherein
the screen generating unit displays a list of the shortest arrival time for each vehicle type on the display.

3. The information processing system of claim 1, wherein
the screen generating unit displays, on the display, pieces of information regarding the types of available vehicles, in order of increasing arrival time.

4. The information processing system of claim 1, wherein
the user terminal further comprises a time deriver configured to derive an arrival time required before a vehicle arrives at the user's position, on the basis of the current position of the user terminal and position information of the vehicle acquired by the information acquirer.

5. The information processing system of claim 1, wherein
the screen generating unit displays information regarding the type of each vehicle of which the arrival time is a predetermined period of time or less.

6. The information processing system of claim 1, wherein:
status information managed by the management unit includes traveling state information indicating whether a vehicle is traveling or parked;
the providing unit provides status information of a vehicle including traveling state information to the user terminal; and
the screen generating unit displays, on the display, a list in which information regarding the types of vehicles that can be delivered is separated from information regarding the types of vehicles that can be driven from parking areas.

7. The information processing system of claim 1, wherein
the screen generating unit displays, as a list on a display, attribute information of a staff member who can deliver a vehicle to a user, and an arrival time required before the vehicle arrives at the user's position.
